(19) United States
(12) Patent Application Publication
(10) Pub. No.: US 2008/0194362 A1
(43) Pub. Date: Aug. 14, 2008

(54) RESILIENT BASEBALL AND METHOD OF MANUFACTURE

(75) Inventors: Paul HELMER, Mesa, AZ (US); David H. REDMOND, Portland, OR (US); Edgar D. GILLESPIE, Reserve, NM (US); Howard W. VIPPERMAN, La Habra Heights, CA (US)

Correspondence Address: KOLISCH HARTWELL, P.C., 520 SW YAMHILL STREET, Suite 200, PORTLAND, OR, 97204, US

(73) Assignees: Paul Helmer, Mesa, AZ (US); Joanne Helmer, Mesa, AZ (US); TIDELINE INTERNATIONAL COMPANY, Portland, OR (US)

(21) Appl. No.: 11/672,646

(22) Filed: Feb. 8, 2007

(51) Int. Cl. A63B 37/00; A63B 43/00; B29C 71/02

(52) U.S. Cl. 473/597; 264/48

(57) ABSTRACT

A molded resilient baseball comprises a foamed and cured elastomer having an outer surface with a grippable texture, wherein the resilient baseball is configured to substantially replicate the weight and the circumference of a regulation baseball.

### BACKGROUND OF THE DISCLOSURE

Baseball is a popular sport in America and throughout the rest of the world. An official regulation Major League Baseball weighs between 5 and 5.25 ounces avoirdupois, measures between 9 and 9.25 inches in circumference, and is a sphere covered with two stripes of white horsehide or cowhide, tightly stitched together. A regulation baseball launched at about 60 MPH at a wall will exhibit a coefficient of restitution between 0.514 and 0.578.

A person generally desires playing with a baseball having the appropriate size, weight, look, and feel of a regulation baseball. Unfortunately, during use, for example when throwing the ball against a wall, the outer hide shell of a regulation baseball may scuff or tear. Also, a regulation baseball does not have the requisite resiliency to consistently rebound to the thrower after hitting against a wall, throw after throw.

Sponge rubber baseballs have been manufactured to resemble baseballs, but typically fail to replicate the look, feel, size, and weight of a regulation baseball. For example, Franklin Sports, Inc. (Stoughton, Mass.) manufactures a rubber baseball that weighs approximately 4.3 ounces and is embossed with only 97 imitation stitches (fewer than the regulation 108 stitches). Moreover, the Franklin rubber baseball feels softer and looks smaller than a regulation baseball. What is needed is a resilient and durable baseball that closely resembles or replicates the look, feel, size, and weight of a regulation baseball, but is both affordable and more durable than a regulation baseball.

### SUMMARY OF THE DISCLOSURE

A molded resilient baseball comprises a foamed and cured elastomer having an outer surface with a grippable texture, wherein the resilient baseball is configured to substantially replicate the weight and the circumference of a regulation baseball.

### BRIEF DESCRIPTION OF THE DRAWINGS

FIG. 1 is a front view of a resilient ball according to the present disclosure.

FIG. 2 is a side view of a resilient ball according to the present disclosure.

FIG. 3 is a sectional view of a resilient ball according to the present disclosure.

FIG. 4 is a flowchart depicting the steps of preparing a resilient ball according to the present disclosure.

### DETAILED DESCRIPTION OF THE DISCLOSURE

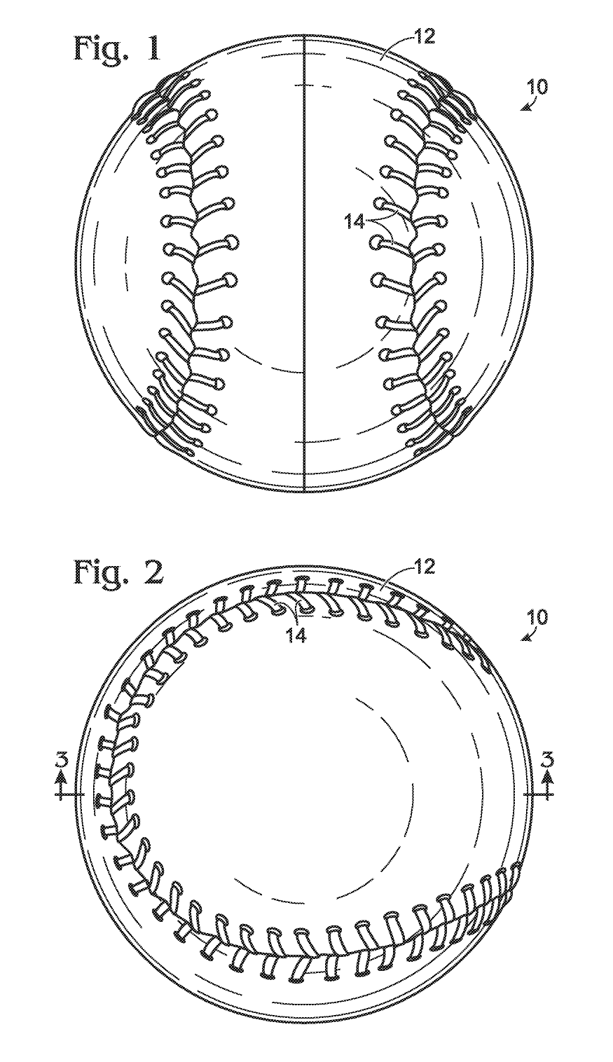

FIGS. 1 and 2 depict a resilient ball 10 having an outer surface 12 with raised stitches 14. Ball 10 may be configured to substantially replicate the look, feel, size, and/or weight of a regulation baseball. For example, ball 10 may have a diameter of about 2.904 inches (plus or minus 0.04 inches), with a total circumference of about 9 inches to about 9.25 inches. Outer surface 12 may substantially replicate the outer hide shell of a regulation baseball. Outer surface 12 may be shaped like a sphere, and may be slightly tacky or textured to aid in gripping the ball. Outer surface 12 may be white in color. Outer surface 12 may be molded to incorporate raised stitches 14 configured to substantially replicate the stitching pattern of a regulation baseball. In order to more closely replicate a regulation baseball, outer surface 12 may include 108 raised stitches 14. Raised stitches 14 and outer surface 12 may be molded out of the same material as ball 10 itself. Raised stitches 14 may be configured to allow ball 10 to be thrown with a substantially similar rotation as a regulation ball (e.g., curves, sliders, knuckleballs, etc.). Raised stitches 14 may have the same color as the rest of outer surface 12, or may be colored using a suitable colorant, either incorporated internally, or applied externally. For example, raised stitches 14 may be colored red using a suitable colorant.

Ball 10 is typically more durable and more resilient than a regulation baseball. Ball 10 may generally be thrown against a wall without tearing or scuffing. Ball 10 may also consistently rebound towards a thrower after striking a wall.

Ball 10 typically is formed from a cured mixture that includes an elastomer, a colorant, and a blowing or foaming agent, among additional additives or residual compounds. The elastomer used in preparing the ball may be any suitable compound for configuring ball 10 to be durable and resilient, and to substantially replicate the look, weight, size, and/or feel of a regulation baseball. The elastomer may be a thermoset or thermoplastic elastomer, and may be natural or synthetic. The elastomer may include a polyolefin elastomer, such as an ethylene-octene copolymer. One suitable elastomer for the purposes of this disclosure is sold under the trade name ENGAGE 8200 (Dow Chemical Company). However, other suitable elastomers may include polyurethanes, styrene copolymers, elastomeric alloys, copolyesters, or other olefins, alone or in combination.

Any suitable colorant may be used to impart one or more colors to the ball. The colorant may be a pigment, paint, or dye. In particular, a suitable colorant may be selected to impart a color to ball 10 in order to substantially replicate that of a regulation baseball. In this case, the colorant is typically a white pigment, such as titanium dioxide.

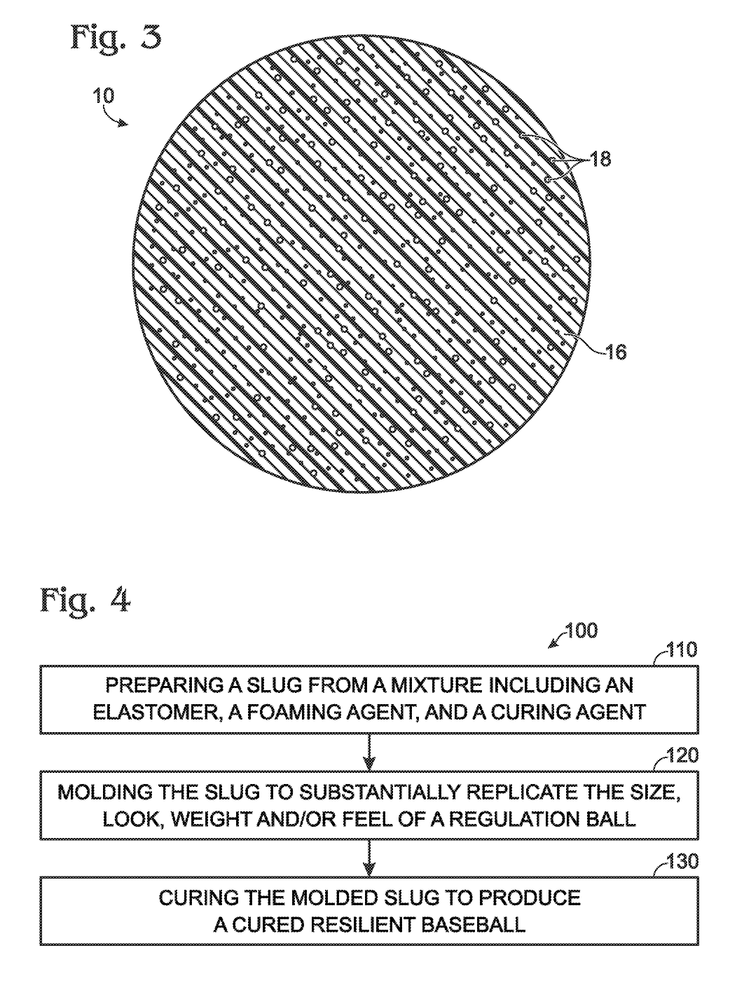

As shown in FIG. 3, ball 10 has an inner core 16 with bubbles 18 dispersed throughout inner core 16. The foaming agent may be used to form inner core 16 with a generally homogenous composition, including bubbles 18. Bubbles 18 in inner core 16 are typically trapped gaseous products of the decomposition of the foaming agent. The foaming agent may help contribute to the physical characteristics of the resulting ball. For example, the foaming agent may shape the circumference or diameter of ball 10.

Any foaming agent that produces a resilient ball that substantially replicates a regulation baseball is a suitable foaming agent. More particularly, the foaming agent may include azodicarbonamide blended with activators selected to reduce decomposition temperature. In one exemplary formulation, the foaming agent is sold as EC (AZ-130) 72.

Ball 10 may further comprise auxiliary additives and/or traces or residue of other compounds used in the manufacturing process of ball 10, such as traces or residues of an activating agent and/or a curing agent, as discussed below.

Ball 10 is configured to weigh substantially the same as a regulation baseball, between about 5 ounces and about 5.25 ounces (137 grams to about 145 grams). In one example, ball 10 may have a weight of about 5.1 ounces (about 141 grams).

Ball 10 may also exhibit the hardness of a regulation baseball, having a density in the range of about 0.679 g/cc to about 0.704 g/cc, and a durometer Shore A hardness of about 70 points (plus or minus about 5 points).

When compared to sponge rubber baseballs, a ball of the present disclosure exhibits enhanced resiliency and playability. An example of the increased resiliency of a selected embodiment of a ball according to the present disclosure over the Franklin rubber baseball (as discussed above) is disclosed in TABLE 1. A drop test was performed where both a ball according to the present disclosure and the Franklin rubber ball were dropped from a height of eight feet. TABLE 1 shows the measured height in inches of the first bounce off the ground for each ball.

TABLE 1

| Test Number | Resilient Ball | Franklin rubber ball |
|---|---|---|
| 1 | 57″ | 54″ |
| 2 | 59″ | 54″ |
| 3 | 59″ | 49″ |
| 4 | 57″ | 52″ |
| 5 | 56″ | 49″ |
| 6 | 61″ | 52″ |
| 7 | 61″ | 53″ |
| 8 | 58″ | 50″ |
| 9 | 61″ | 50″ |
| 10 | 60″ | 53″ |
| Average | 59″ | 52″ |

As shown in TABLE 1, a resilient ball according to the present disclosure is generally more resilient or bouncy than the Franklin rubber ball.

TABLE 2 discloses the results of a test to determine the coefficient of restitution (COR) of a selected embodiment of a ball according to the present disclosure. Ten balls according to the present disclosure were each fired against a concrete wall 65 times at about 60 MPH, 65 times at about 80 MPH, and 70 times at about 100 MPH. Three balls according to the present disclosure were each fired against a two-inch thick steel plate 20 times at about 200 MPH. The inbound and rebound speeds were measured for each impact. TABLE 2 summarizes the COR values exhibited for the different impact speeds.

TABLE 2

| Impact Speed of Resilient Ball | Coefficient of Restitution |
|---|---|
| ~60 MPH | ~0.68 |
| ~80 MPH | ~0.61 |
| ~100 MPH | ~0.56 |
| ~160 MPH | ~0.45 |
| ~200 MPH | ~0.37 |

As TABLE 2 shows, a ball according to the present disclosure is more resilient or bouncy than a regulation baseball. The test also showed increased durability because all the tested balls according to the present disclosure did not tear, break, or show other significant permanent deformation after the multiple impacts.

The manufacture of sponge rubber baseballs has been previously disclosed in U.S. Pat. No. 3,308,223. Additionally, an example of curing a rubber compound is disclosed in U.S. Pat. No. 7,053,137. The disclosures of these patents are incorporated herein by reference for all purposes.

Now turning to FIG. 4, a process 100 for manufacturing a ball of the present disclosure is generally outlined. Process 100 may include generally at 110 preparing a slug from a mixture including an elastomer, a foaming agent, and a curing agent. Process 100 may further include generally at 120 molding the slug to substantially replicate the size, weight, look, and/or feel of a regulation baseball, and generally at 130 curing the molded slug to produce a cured resilient ball.

The following method is an illustrative, non-exclusive example of process 100 for manufacturing a resilient ball. TABLE 3 discloses the ingredients used in this example.

TABLE 3

| Ingredient | PHR* |
|---|---|
| ENGAGE 8200 Polyolefin Elastomer | 100.0 |
| (ethylene-octene copolymer) | |
| Titanium Dioxide (TiO₂), (colorant) | 1.1 |
| Zinc Oxide (ZnO) Paste 85% (activator) | 7.0 |
| EC (AZ-130)72 (blowing agent) | 1.7 |
| VAROX 802 SP-40MB Powder (peroxide-based | 5.0 |
| cross-linking agent, R. T. Vanderbilt Company, | |
| Inc.) | |
| TOTAL | 114.8 |

*PHR = parts per hundred of rubber

An uncured heated mixture comprising an elastomer, an activating agent, and a colorant may be mixed. In this example, the uncured heated mixture includes about 100 parts per hundred of rubber (PHR) of uncured ENGAGE 8200, about 1.1 PHR of titanium dioxide, and about 7.0 PHR of zinc oxide paste 85%. The uncured heated mixture is masticated using a heated banbury mixing machine, such as those manufactured by the Farrel Corporation. Mastication is a type of mixing used to turn larger elastomeric molecules into smaller units for improving plasticity and reducing viscosity. Other suitable machines configured for masticating rubber could also be used.

The mastication process may help homogenize ENGAGE 8200, the titanium dioxide, and the zinc oxide paste 85%. Typically, homogenization occurs at a temperature between about 150° F. to about 212° F. In this example, homogenization occurs when the temperature is above about 150° F., and after about three minutes of masticating. The banbury machine may require preheating to above about 150° before adding the elastomer, the activating agent, and the colorant. The banbury machine may be heated simply using the frictional heat generated by mastication or by using a heater. The temperature of the mixture may be monitored using any suitable means. To determine when homogenization occurs, the energy consumption of the banbury machine may be monitored, such as by using an amp meter or torque sensor.

A blowing agent may be mixed into the uncured heated mixture. In this example, about 1.7 PHR of EC (AZ-130)72 is mixed into the uncured heated mixture in the banbury machine. The EC (AZ-130)72 is added after about five or six minutes of mixing.

A curing or cross-linking agent may be mixed into the uncured heated mixture. In this example, about 5.0 PHR of VAROX 802 SP-40 MB Powder is mixed into the banbury machine when the uncured heated mixture is between about 180° F. to about 200° F. The uncured heated mixture may reach this temperature range after about six minutes of mixing. The uncured heated mixture is mixed until the VAROX 802 SP-40MP Powder becomes pliable. The mixing typically occurs below about 212° F. in order to prevent setting off (activating) or cross-linking (vulcanizing). The mixture may begin setting off at about 212° F. and cross-linking at about 240° F.

Slugs of the heated uncured mixture may be prepared for molding and curing. The uncured heated mixture typically is dropped out of the banbury machine before reaching about 212° F. Typically, the uncured heated mixture is mixed for about 45 seconds after adding VAROX 802 SP-40MB before being dropped from the banbury machine. Typically, when the amp meter or torque sensor shows that the energy consumption of the banbury machine has leveled out, the uncured heated mixture is ready to be dropped. After being dropped from the banbury machine, the uncured heated mixture is allowed to stabilize into an uncured stabilized mixture. In an exemplary process, the mixture is allowed to stabilize for about eight hours. The stabilization period may be suitably shortened or lengthened as desired.

The uncured stabilized mixture may be prepared for molding and curing using a barwell preparation. A barwell preparation is any suitable process, such as extruding or milling and cutting, for forming the uncured stabilized mixture into slugs, cylinders, etc. having the desired weight and size of a cured finished product. In this example, a slug is extruded that will yield through molding a cured resilient ball substantially replicating the size and weight of a regulation baseball. The slug may be about 2.10 inches in diameter, and weigh between about 137 grams and about 147 grams. The slug may need to harden before molding and curing. In this example, the slug is allowed to cool and harden for about 24 hours before being cured and molded.

The slug may be molded into a cured resilient ball configured to substantially replicate a regulation baseball. Any suitable technique for molding an elastomer may be used, such as compression molding, injection molding, thermoforming, urethane casting, or dip molding. In this example, the slug is cured and molded under suitable pressure conditions in a suitably heated compression mold. The compression mold is configured to yield a ball 10 having a diameter of about 9 inches to about 9.25 inches, and an outer surface having a spherical shape with raised stitches.

Preheating the compression mold to a suitable temperature for curing and molding before adding the slug or cylinder may be desirable. Preheating the compression mold to about 320° F. may be desirable. Curing at lower temperatures (below about 320° F.) may require more molding time. Curing at higher temperatures (above about 320° F.) may over-activate the blowing agent, resulting in a distorted or defective cured ball. The curing process in the compression mold also decomposes the azodicarbonamide into gaseous products that become trapped in inner core 16 as bubbles 18. In this example, the slug was molded and cured for about 30 to 47 minutes in the compression mold at about 320° F. and at a firm pressure of about 1400 PSI. The slug yielded a cured resilient ball substantially resembling a regulation baseball.

The molded ball may be removed from the mold and placed in a rounded or spherical shaped holder for a suitable amount of time to allow the ball to harden. In this example, the ball was allowed to harden for about 24 hours before being handled. A colorant may be applied to the raised stitches of the molded and cured ball, for example, to substantially replicate the red stitching of a regulation baseball. In some embodiments, the colorant may be applied to the raised stitches during the molding and/or curing process.

The present disclosure may encompass other exemplary embodiments. In some embodiments, a ball according to the present disclosure may be sold as a stand-alone toy or as part of a kit which could include a bat, a glove, bases, etc. In some embodiments, a ball according to the present disclosure may be configured to substantially resemble or replicate the size, weight, look, and/or feel of a tee-ball, softball, lacrosse ball, golf ball, hockey puck, or any other ball desired. In some embodiments, the outer surface may include indicia or surface markings, including the name of or trademark for a ball according to the present disclosure, the logo of a professional baseball team, etc.

The outer surface may be configured to enhance or change the performance characteristics of a ball according to the present disclosure, for example, by providing a dimpled surface characteristic of golf balls. The outer surface may also include any other texture that would enhance the ability to grip or throw a ball according to the present disclosure. Alternatively, a ball according to the present disclosure may incorporate an additional skin, sheath, or other surface covering. A ball according to the present disclosure may be colored in any of a variety of colors, either by dispersing colorant throughout the ball composition, or by surface coloring during or after manufacture.

In some embodiments, the inner core may be configured to enhance or change the performance characteristics of a ball according to the present disclosure. The inner core may be a different material than the outer surface. The inner core may include a weight (either centered or off-centered) or be hollow, etc.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where any claim recites “a” or “a first” element or the equivalent thereof, such claim should be understood to include incorporation of one or more such elements, neither requiring nor excluding two or more such elements.

Inventions embodied in various combinations and subcombinations of features, functions, elements, and/or properties may be claimed through presentation of new claims in a related application. Such new claims, whether they are directed to a different invention or directed to the same invention, whether different, broader, narrower or equal in scope to the original claims, are also regarded as included within the subject matter of the inventions of the present disclosure.

We claim:

1. A molded resilient baseball comprising a foamed and cured elastomer having an outer surface with a grippable texture, wherein the resilient baseball is configured to substantially replicate the weight and the circumference of a regulation baseball.

2. The cured resilient baseball of claim 1, further comprising a colorant dispersed throughout the cured elastomer.

3. The cured resilient baseball of claim 1, wherein the resilient baseball exhibits a coefficient of restitution between about 0.37 and about 0.68.

4. The cured resilient baseball of claim 1, wherein the elastomer is a polyolefin elastomer.

5. The cured resilient baseball of claim 4, wherein the polyolefin elastomer is an ethylene-octene copolymer.

6. The cured resilient baseball of claim 1, wherein the resilient baseball has a density of about 0.679 g/cc to about 0.704 g/cc.

7. The cured resilient baseball of claim 1, wherein the resilient baseball has a weight of about 5 ounces to about 5.25 ounces.

8. The cured resilient baseball of claim 1, wherein the resilient baseball has a circumference of about 9 inches to about 9.25 inches.

9. The cured resilient baseball of claim 1, wherein the grippable texture of the outer surface includes molded simulated stitching.

10. The cured resilient baseball of claim 9, wherein the simulated stitching includes about 108 simulated stitches.

11. A resilient baseball configured to substantially replicate the weight and the circumference of a regulation baseball, comprising a foamed molded and cured elastomer, wherein the baseball has a substantially spherical outer surface and a Shore A hardness of about 65 to about 75.

12. The resilient baseball of claim 11, wherein the baseball has a weight of about 5 ounces to about 5.25 ounces, a circumference of about 9 inches to about 9.25 inches, and a surface texture that includes about 108 molded simulated stitches.

13. A process for producing a cured resilient baseball comprising the steps of:
preparing a slug from a mixture including an elastomer, a foaming agent, and a curing agent;
molding the slug to substantially replicate the weight and the circumference of a regulation ball; and
curing the molded slug to produce the cured resilient baseball.

14. The process of claim 13, wherein the slug is cured is for about 30 minutes to about 47 minutes at about 320° F. and at about 1400 PSI.

15. The process of claim 13, wherein preparing the slug includes preparing a mixture including an elastomer that is an ethylene-octene copolymer.

16. The process of claim 13, wherein preparing the slug includes preparing a mixture including the elastomer at a concentration of about 100 parts per hundred of rubber, the foaming agent at a concentration of about 1.7 parts per hundred of rubber, and the curing agent at a concentration of about 5.0 parts per hundred of rubber.

17. The process of claim 13, wherein preparing the slug comprises:
preparing an uncured heated mixture including the elastomer;
mixing a foaming agent into the uncured heated mixture; and
mixing a curing agent into the uncured heated mixture.

18. The process of claim 17, wherein preparing the slug includes masticating the elastomer at about 150° F., mixing the foaming agent with the elastomer, and mixing the curing agent with the resulting mixture at about 180° F. to about 200° F.

19. The process of claim 17, further comprising mixing a colorant and an activating agent into the uncured heated mixture, wherein the colorant is present at a concentration of about 1.1 parts per hundred of rubber and the activating agent is present at a concentration of about 7.0 parts per hundred of rubber.

20. The process of claim 13, wherein the cured resilient baseball has a weight of about 5 ounces to about 5.25 ounces, a circumference of about 9 inches to about 9.25 inches, a density of about 0.679 g/cc to about 0.704 g/cc, and a Shore A hardness of about 65 to about 75, and exhibits a coefficient of restitution between about 0.37 and about 0.68.
